(19) United States
(12) Patent Application Publication
(10) Pub. No.: US 2021/0199749 A1
(43) Pub. Date: Jul. 1, 2021

(54) DEVICE DISTANCE ESTIMATION FOR VEHICLE ACCESS

(71) Applicant: Continental Automotive Systems Inc., Auburn Hills, MI (US)

(72) Inventors: Aaron Adler, Rochester Hills, MI (US); Djordje Preradovic, Shelby Township, MI (US); Akshay Choudhari, Troy, MI (US)

(21) Appl. No.: 16/729,588

(22) Filed: Dec. 30, 2019

(51) Int. Cl. G01S 5/14; G01S 5/02; H04W 4/02; H04W 4/40

(52) U.S. Cl. CPC G01S 5/14; G01S 5/0289; H04W 4/40; H04W 4/023; G01S 5/0294

(57) ABSTRACT

A system and method includes, among other things, providing at least three vehicle transceivers, communicating with each vehicle transceiver via a remote device, and estimating a distance to the remote device for each vehicle transceiver. Estimated distances from the at least three vehicle transceivers and trilateration are used to determine an actual distance of the remote device from the vehicle.

### TECHNICAL FIELD

The present disclosure relates to a method and system for determining a distance between a remote device and a vehicle, and more particularly to a method and system that determines the distance via trilateration.

### BACKGROUND

Vehicle users often have devices such as key fobs, cellphones, asset tags, etc. that are used to provide hands-free access their vehicles. The devices typically include a control unit within the device, a processing unit within the vehicle and transmission devices arranged in the vehicle and integrated into the device control unit such that communication can be established between the vehicle and the device to implement procedures for authorizing access to the vehicle. Access is typically allowed within a certain range or distance of the user relative to the vehicle. The determination of the distance needs to be accurate and the communication protocols need to be secure in certain applications.

The background description provided herein is for the purpose of generally presenting a context of this disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method according to an exemplary embodiment of this disclosure, includes, among other possible things: providing at least three vehicle transceivers; communicating with each vehicle transceiver via a remote device; estimating a distance to the remote device for each vehicle transceiver; and using estimated distances from the at least three vehicle transceivers and trilateration to determine an actual distance of the remote device from the vehicle.

In a further embodiment of the foregoing method, the method includes using phase based ranging to determine the estimated distances.

In a further embodiment of any of the foregoing methods, the method includes using timestamp based ranging to determine the estimated distances.

In a further embodiment of any of the foregoing methods, the method includes using phase based ranging and timestamp based ranging to determine the estimated distances.

In a further embodiment of any of the foregoing methods, the method includes determining a first estimated distance between the remote device and the first vehicle transceiver of the at least three vehicle transceivers that comprises a first circle representing all possible distances at a first radius extending from the first vehicle transceiver to the remote device, determining a second estimated distance between the remote device and the second vehicle transceiver of the at least three vehicle transceivers that comprises a second circle representing all possible distances at a second radius extending from the second vehicle transceiver to the remote device, determining a third estimated distance between the remote device and the third vehicle transceiver of the at least three vehicle transceivers that comprises a third circle representing all possible distances at a third radius extending from the third vehicle transceiver to the remote device, and identifying the actual distance of the remote device from the vehicle as an intersection point between the first, second, and third circles.

In a further embodiment of any of the foregoing methods, the method includes providing wireless communication between each of the at least three vehicle transceivers and the remote device.

In a further embodiment of any of the foregoing methods, the remote device comprises a key fob, cellphone, microchip, or asset tag.

A method according to another exemplary embodiment of this disclosure, includes, among other possible things: providing at least a first vehicle transceiver, a second vehicle transceiver, and a third vehicle transceiver; communicating with the first, second, and third vehicle transceivers via a remote device; estimating a first distance from the first vehicle transceiver to the remote device; estimating a second distance from the second vehicle transceiver to the remote device; estimating a third distance from the third vehicle transceiver to the remote device; and using the first, second, and third estimated distances to determine an actual distance of the remote device from the vehicle via trilateration.

In a further embodiment of any of the foregoing methods, the method includes providing wireless communication between the first, second, and third vehicle transceivers and the remote device.

In a further embodiment of any of the foregoing methods, the method includes using phase based ranging or using timestamp based ranging to determine the first, second, and third estimated distances.

In a further embodiment of any of the foregoing methods, the method includes using phase based ranging and timestamp based ranging to determine the first, second, and third estimated distances

In a further embodiment of any of the foregoing methods, the method includes determining the first distance as comprising a first circle representing all possible distances at a first radius extending from the first vehicle transceiver to the remote device, determining the second distance as comprising a second circle representing all possible distances at a second radius extending from the second vehicle transceiver to the remote device, determining the third distance as comprising a third circle representing all possible distances at a third radius extending from the third vehicle transceiver to the remote device, and identifying the actual distance of the remote device from the vehicle as an intersection point between the first, second, and third circles.

In a further embodiment of any of the foregoing methods, the remote device comprises a key fob, cellphone, microchip, or asset tag.

A system according to an exemplary embodiment of this disclosure, includes, among other possible things, at least three vehicle transceivers in communication with a remote device, wherein an estimated distance to the remote device is determined for each of the at least three vehicle transceivers, and a control unit configured to use trilateration and the estimated distances to determine an actual distance of the remote device from the vehicle.

In a further embodiment of the foregoing system, the estimated distances are determined based on phase based ranging or on timestamp based ranging.

In a further embodiment of any of the foregoing systems, the estimated distances are determined based on phase based ranging and on timestamp based ranging.

In a further embodiment of any of the foregoing systems, the remote device comprises a key fob, cellphone, microchip, or asset tag.

In a further embodiment of any of the foregoing systems, wireless communication is provided between each of the at least three vehicle transceivers and the remote device.

In a further embodiment of any of the foregoing systems, the at least three vehicle transceivers comprise at least a first vehicle transceiver, a second vehicle transceiver, and a third vehicle transceiver, a first distance is estimated from the first vehicle transceiver to the remote device, a second distance is estimated from the second vehicle transceiver to the remote device, and a third distance is estimated from the third vehicle transceiver to the remote device, and the control unit is configured to use the first, second, and third estimated distances to determine the actual distance of the remote device from the vehicle via trilateration.

In a further embodiment of any of the foregoing systems, the control unit is configured to determine the first distance as comprising a first circle representing all possible distances at a first radius extending from the first vehicle transceiver to the remote device, determine the second distance as comprising a second circle representing all possible distances at a second radius extending from the second vehicle transceiver to the remote device, determine the third distance as comprising a third circle representing all possible distances at a third radius extending from the third vehicle transceiver to the remote device, and identify the actual distance of the remote device from the vehicle as an intersection point between the first, second, and third circles.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic overhead view of a vehicle and remote device communicating with each other.

FIG. 2 is similar to FIG. 1 but showing trilateration to determine an actual distance between the remote device and the vehicle.

### DETAILED DESCRIPTION

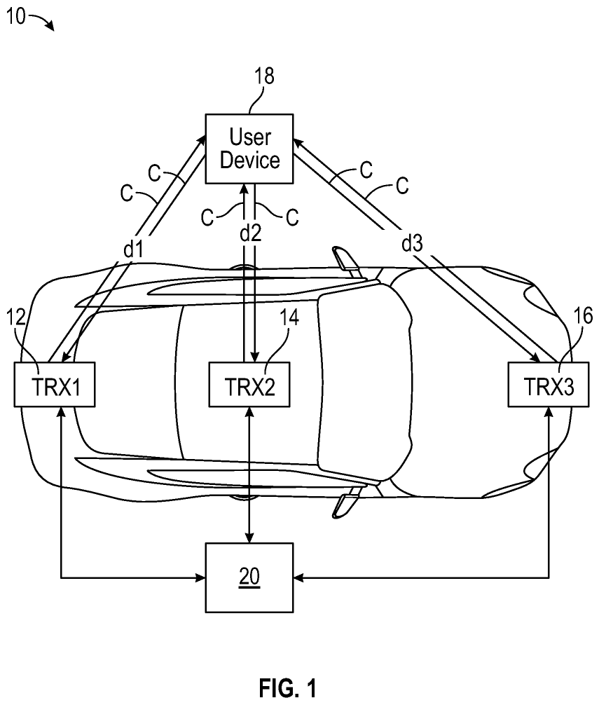

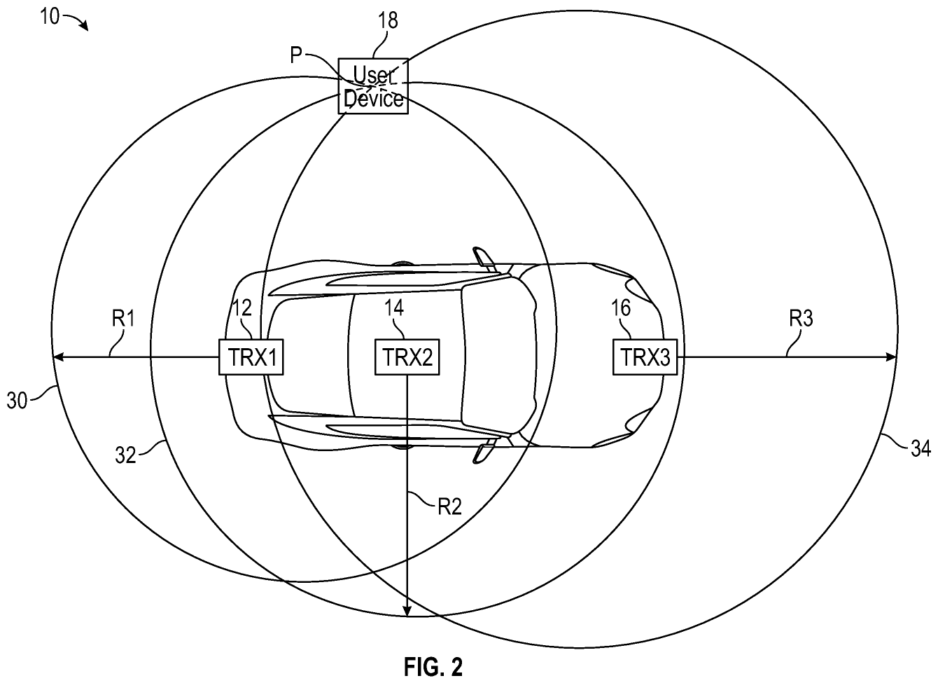

Referring to FIGS. 1 and 2, a vehicle 10 includes at least a first vehicle transceiver 12, a second vehicle transceiver 14, and a third vehicle transceiver 16. The first 12, second 14, and third 16 vehicle transceivers can be placed anywhere within the vehicle 10, outside of the vehicle 10, or in any combination thereof. Additional transceivers can also be installed as needed. A remote device 18 communicates with the first 12, second 14, and third 16 vehicle transceivers. In one example, the remote device 18 comprises a key fob, cellphone, microchip, asset tag, or any other device configured to provide hands-free or remote keyless access to the vehicle 10.

Bi-directional and/or uni-directional communications C between the remote device 18 and the first 12, second 14, and third 16 vehicle transceivers are used to determine respective distances between the transceivers and the remote device. In one example, the communications are wireless communications that are accomplished via Bluetooth or Bluetooth Low Energy (BLE).

A control unit 20 uses the distance data to determine an actual distance of the remote device 18 from the vehicle 10 via trilateration. The control unit 20 can be incorporated as part of one of the first 12, second 14, and third 16 vehicle transceivers, or the control unit 20 can be a vehicle control unit or a separate/dedicated control unit. The remote device 18 may also include a device control unit or microcontroller that is in communication with the control unit 20.

As shown in FIG. 1, a first distance d1 is estimated from the first vehicle transceiver 12 to the remote device 18, a second distance d2 is estimated from the second vehicle transceiver 14 to the remote device 18, and a third distance d3 is estimated from the third vehicle transceiver 16 to the remote device 18. The distance or ranging estimation can be accomplished using phase and/or timestamp based ranging exchanges between the remote device 18 and the transceivers 12, 14, 16.

In phase based ranging, the distance between the remote device 18 and the associated transceiver 12, 14, 16 is estimated by using phase-shift measurements of RF signals over multiple frequencies. In timestamp based ranging, the distance between the remote device 18 and the associated transceiver 12, 14, 16 is estimated by measuring the time for a signal to be sent from a first device to a second device and the time for the second device to send a return signal to the first device. Phase based ranging is more accurate than timestamp based ranging. Timestamp based ranging is more secure than phase based ranging. Phase based ranging can be used when the vehicle is within a visual range of the user; however, timestamp based ranging should be used for applications that are to be secure. In one example, both phase based ranging and timestamp based ranging are used to provide an accurate and secure application.

In one example, the control unit 20 uses the first d1, second d2, and third d3 estimated distances to determine the actual distance of the remote device 18 from the vehicle 10 via trilateration (FIG. 2). Trilateration can be used to determine the distance of the remote device 18 from the vehicle 10 whether the remote device 18 is stationary or moving. One example of a trilateration application comprises mobile phone tracking where localization may occur either via multi-lateration of radio signals between several cell towers and the phone, or simply via GPS.

As shown in FIG. 2, in the subject application, the first estimated distance d1 between the remote device 18 and the first vehicle transceiver 12 comprises a first circle 30 representing all possible distances at a first radius R1 extending from the first vehicle transceiver 12 to the remote device 18. The second estimated distance d2 between the remote device 18 and the second vehicle transceiver 14 comprises a second circle 32 representing all possible distances at a second radius R2 extending from the second vehicle transceiver 14 to the remote device 18. The third estimated distance d3 between the remote device 18 and the third vehicle transceiver 16 comprises a third circle 34 representing all possible distances at a third radius R3 extending from the third vehicle transceiver 16 to the remote device 18. The actual distance of the remote device 18 from the vehicle 10 is then identified as an intersection point P between the first 30, second 32, and third 34 circles.

An example of how the intersection point P is determined is discussed below. In this example, a 2D model is used based on x-y coordinates as an alternative to longitude/latitude coordinates. Each transceiver 12, 14, 16 is at a center of its respective circle 30, 32, 34, with the center being defined by the x-y coordinates. The first circle 30 has first coordinates (x₁, y₁), the second circle 32 has second coordinates (x₂, y₂), and the third circle 34 has third coordinates (x₃, y₃). The remote device 18 has the intersection coordinates (x, y) at the intersection point P.

The three equations for the three circles are as follows:

(x−x₁)²+(y−y₁)²=r₁²

(x−x₂)²+(y−y₂)²=r₂²

(x−x₃)²+(y−y₃)²=r₃²

Next, the squares are expanded out each equation:

x²−2x₁x+x₁²+y²−2y₁y+y₁²=r₁².

x²−2x₂x+x₂²+y²−2y₂y+y₂²=r₂².

x²−2x₃x+x₃²+y²−2y₃y+y₃²=r₃².

Next, the second equation is subtracted from the first equation:

(−2x₁+2x₂)x+(−2y₁+2y₂)y=r₁²−r₂²−x₁²+x₂²−y₁²+y₂²

Next, the third equation is subtracted from the second equation:

(−2x₂+2x₃)x+(−2y₂+2y₃)y=r₂²−r₃²−x₂²+x₃²−y₂²+y₃²

Next, these two equations are rewritten using A, B, D, E, F values to result in the following system of 2 equations:

Ax+By=C

Dx+Ey=F

The solution of the system is:

$$x = \frac{CE - FB}{EA - BD}$$

$$y = \frac{CD - AF}{BD - AE}$$

These equations can then be implemented in an algorithm, such as a Python algorithm for example, using a function that will take the nine parameters (x₁, y₁, r₁, x₂, y₂ r₂, x₃, y₃, r₃) and return the (x,y) coordinates of the intersection point P of the three circles. In one example, the control unit 20 is utilized to execute the algorithm.

In one example, the control unit 20 or system controller can include a processor, memory, and one or more input and/or output (I/O) device interface(s) that are communicatively coupled via a local interface. The local interface can include, for example but not limited to, one or more buses and/or other wired or wireless connections. The controller may be a hardware device for executing software, particularly software stored in memory. The controller can be a custom made or commercially available processor, a central processing unit (CPU), an auxiliary processor among several processors associated with the computing device, a semiconductor based microprocessor (in the form of a microchip or chip set) or generally any device for executing software instructions.

The memory can include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The software in the memory may include one or more separate programs, each of which includes an ordered listing of executable instructions for implementing logical functions. The controller can be configured to execute software stored within the memory, to communicate data to and from the memory, and to generally control operations of the computing device pursuant to the software. Software in memory, in whole or in part, is read by the processor, perhaps buffered within the processor, and then executed.

The subject disclosure provides a system and method for distance approximation around a vehicle using Bluetooth or BLE, for example, to communicate with three or more vehicle transceivers. The distance approximation is accomplished using phase based and/or timestamp based ranging, for example. The use of three transceivers allows ranging estimation via trilateration, which significantly increases the accuracy of distance estimation between the user/remote device and the vehicle. Using more than three transceivers will further increase the accuracy. Phased based ranging allows single antenna implementation of RF ranging with high accuracy, while timestamp based ranging allows replay protection against vehicle security attacks.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A method comprising:
providing at least three vehicle transceivers;
communicating with each vehicle transceiver via a remote device;
estimating a distance to the remote device for each vehicle transceiver; and
using estimated distances from the at least three vehicle transceivers and trilateration to determine an actual distance of the remote device from the vehicle.

2. The method according to claim 1, including using phase based ranging to determine the estimated distances.

3. The method according to claim 1, including using timestamp based ranging to determine the estimated distances.

4. The method according to claim 1, including using phase based ranging and timestamp based ranging to determine the estimated distances.

5. The method according to claim 1, including:
determining a first estimated distance between the remote device and the first vehicle transceiver of the at least three vehicle transceivers that comprises a first circle representing all possible distances at a first radius extending from the first vehicle transceiver to the remote device,
determining a second estimated distance between the remote device and the second vehicle transceiver of the at least three vehicle transceivers that comprises a second circle representing all possible distances at a second radius extending from the second vehicle transceiver to the remote device,
determining a third estimated distance between the remote device and the third vehicle transceiver of the at least three vehicle transceivers that comprises a third circle representing all possible distances at a third radius extending from the third vehicle transceiver to the remote device, and
identifying the actual distance of the remote device from the vehicle as an intersection point between the first, second, and third circles.

6. The method according to claim 1, including providing wireless communication between each of the at least three vehicle transceivers and the remote device.

7. The method according to claim 1, wherein the remote device comprises a key fob, cellphone, microchip, or asset tag.

8. A method comprising:
providing at least a first vehicle transceiver, a second vehicle transceiver, and a third vehicle transceiver;
communicating with the first, second, and third vehicle transceivers via a remote device;
estimating a first distance from the first vehicle transceiver to the remote device;
estimating a second distance from the second vehicle transceiver to the remote device;
estimating a third distance from the third vehicle transceiver to the remote device; and
using the first, second, and third estimated distances to determine an actual distance of the remote device from the vehicle via trilateration.

9. The method according to claim 8, including providing wireless communication between the first, second, and third vehicle transceivers and the remote device.

10. The method according to claim 9, including using phase based ranging or using timestamp based ranging to determine the first, second, and third estimated distances.

11. The method according to claim 9, including using phase based ranging and timestamp based ranging to determine the first, second, and third estimated distances

12. The method according to claim 9, including
determining the first distance as comprising a first circle representing all possible distances at a first radius extending from the first vehicle transceiver to the remote device,
determining the second distance as comprising a second circle representing all possible distances at a second radius extending from the second vehicle transceiver to the remote device,
determining the third distance as comprising a third circle representing all possible distances at a third radius extending from the third vehicle transceiver to the remote device, and
identifying the actual distance of the remote device from the vehicle as an intersection point between the first, second, and third circles.

13. The method according to claim 9, wherein the remote device comprises a key fob, cellphone, microchip, or asset tag.

14. A system comprising:
at least three vehicle transceivers in communication with a remote device, wherein an estimated distance to the remote device is determined for each of the at least three vehicle transceivers; and
a control unit configured to use trilateration and the estimated distances to determine an actual distance of the remote device from the vehicle.

15. The system according to claim 14, wherein the estimated distances are determined based on phase based ranging or on timestamp based ranging.

16. The system according to claim 14, wherein the estimated distances are determined based on phase based ranging and on timestamp based ranging.

17. The system according to claim 14, wherein the remote device comprises a key fob, cellphone, microchip, or asset tag.

18. The system according to claim 14, wherein wireless communication is provided between each of the at least three vehicle transceivers and the remote device.

19. The system according to claim 14, wherein:
the at least three vehicle transceivers comprise at least a first vehicle transceiver, a second vehicle transceiver, and a third vehicle transceiver,
a first distance is estimated from the first vehicle transceiver to the remote device, a second distance is estimated from the second vehicle transceiver to the remote device, and a third distance is estimated from the third vehicle transceiver to the remote device, and
wherein the control unit is configured to use the first, second, and third estimated distances to determine the actual distance of the remote device from the vehicle via trilateration.

20. The system according to claim 19, wherein the control unit is configured to:
determine the first distance as comprising a first circle representing all possible distances at a first radius extending from the first vehicle transceiver to the remote device,
determine the second distance as comprising a second circle representing all possible distances at a second radius extending from the second vehicle transceiver to the remote device,
determine the third distance as comprising a third circle representing all possible distances at a third radius extending from the third vehicle transceiver to the remote device, and
identify the actual distance of the remote device from the vehicle as an intersection point between the first, second, and third circles.
